(19) United States
(12) Patent Application Publication
(10) Pub. No.: US 2008/0122308 A1
(43) Pub. Date: May 29, 2008

(54) Method for Stabilizing a Magnetically Levitated Object

(75) Inventor: Michel Saint Mleux, Rosny Sous Bois (FR)

Correspondence Address: CANTOR COLBURN, LLP, 20 Church Street, 22nd Floor, Hartford, CT, 06103, US

(73) Assignee: LEVISYS, ROSNEY-SOUS-BOIS (FR)

(21) Appl. No.: 11/816,216

(22) PCT Filed: Feb. 15, 2006
(86) PCT No.: PCT/FR06/00340

§ 371 Date: Sep. 19, 2007

(30) Foreign Application Priority Data
Feb. 15, 2005 (FR) 0501514

(51) Int. Cl. F16C 32/04

(52) U.S. Cl. 310/90.5; 310/68 B

(57) ABSTRACT

The invention relates to a method for stabilising a magnetically levitated object (2, 21, 31, 32, 52, 200) subjected to a constant magnetic field, said object being stable in at least one direction and unstable in at least one other direction. The inventive method is characterised in that it comprises a stabilisation step, which is repeated as often as required, and consists in applying an electrical current through at least one conductive element (15a to 16c, 27, 44, 62, 211) subjected to a secondary magnetic field in such a way as to generate a compensating Laplace force in the direction of instability. The invention also relates to a magnetic levitation device (1, 20, 30, 50) stabilised by the inventive method.

The present invention relates to a method for stabilizing a magnetically levitated object and to a magnetic levitation device.

Magnetic fields can be used to generate forces in various actuators allowing them to undergo frictionless movement and noiseless operation. Such a means of actuation is used when conventional mechanical systems reach their limits and are no longer suitable. More particularly, there are applications that require very high rotation speeds, for which it is especially necessary to minimize frictional losses and/or to avoid wear, and/or where it is impossible to employ lubricants.

Examples of applications for which these advantages are most particularly desirable are, among others, inertial flywheel systems, which constitute devices for storing energy in kinetic energy form in a wheel rotating at several thousand revolutions per minute, and magnetically levitated trains for which only air friction remains, which trains may reach speeds greatly in excess of 400 km/h.

Most currently available magnetic actuators use magnetic levitation only in one degree of freedom. This is the case of an electric motor in which only the magnetic forces for driving the rotor are used.

In the case of most of these applications, it is particularly desirable to minimize the existing friction so as to reduce the energy losses and the noise that they generate, and it generally proves necessary, in order to do this, to have to magnetically control an object in several degrees of freedom.

Now, when it is desired to keep an object in complete levitation by the use of magnetic fields, that is to say having the six degrees of freedom in space, it proves to be particularly difficult to stabilize it. In 1839, the scientist S. Earnshaw demonstrated that it was impossible to stabilize a magnetically polarized particle in a static field. As a result, it is impossible to stabilize a ferromagnetic body in magnetic levitation using permanent magnets or ferromagnetic elements. Several solutions for obviating Earnshaw's law have however been devised and are currently used to stabilize magnetically levitated objects.

A first solution consists in using a diamagnetic material. Such a material, unlike a ferromagnetic material which possesses a permanent magnetization, develops a magnetic field in reaction to an external magnetic field to which it is subjected. This induced magnetic field tends to oppose the external magnetic field by always being antiparallel thereto, and consequently it always opposes the field variations caused by the levitated object when the latter moves away from its equilibrium position. There exists therefore a restoring force that keeps the object stable. This is the case for magnetic levitation using superconductors. However, this solution is difficult to implement as these materials must generally be cooled to a very low temperature in liquid nitrogen in order to be able to achieve the superconductivity state. Consequently, this method, although satisfactory from a theoretical standpoint, remains particularly tricky to put into practice and requires cryogenic means that consume a very large amount of energy.

A second solution consists in using electromagnets. This is because, in the same way that a diamagnetic material permanently develops a magnetic field opposite the external magnetic field to which it is subjected, it is possible to modify the field developed by an electromagnet so that it offsets a deviation of the levitated object from the desired equilibrium position. Earnshaw's law is therefore not violated, the magnetic levitation remaining impossible if constant electrical currents flow through the electromagnets, and therefore develop stable magnetic fields, but circumvented by adjusting the magnetic fields developed by the electromagnets, which are therefore variable, and also the resulting directions of these fields.

A third solution consists in using alternating fields generated by coils. The field variations generate induced currents, called eddy currents, in a conducting object, these currents then creating a repulsive force that may be sufficient to lift the object.

However, the second and third solutions have major drawbacks because of the electrical power needed to generate sufficiently intense magnetic fields using electromagnets and coils. Moreover, the need to permanently control the magnetic field developed by the electromagnets requires installing a complex control system, which also consumes electrical power and which must have an extremely short response time. This constraint is difficult to achieve because of generally nonlinear transfer functions of such a system. Such a levitation mode is said to be “active”, as opposed to a levitation using permanent magnets, which do not consume additional energy, and which is therefore called “passive” levitation.

A fourth solution should be mentioned, which makes it possible to keep an object possessing permanent magnetization in levitation in a field that is also permanent. This object is sold under the trademark LEVITRON® and takes the form of a top that can be kept levitated in a stable magnetic field when it is rotating. Contrary to appearances, this object does not violate Earnshaw's law. This is because the instability inherent in any levitation system in a stable field is always present, this being, however, compensated for by a stabilizing gyroscopic effect coming from the rotation of the top. However, the equilibrium thus obtained is relatively unstable and the stability conditions are particularly strict. Thus, the mass of the top must be very precisely adjusted, and likewise its rotation speed and the direction of the magnetic field relative to the direction of gravity.

To alleviate several of these drawbacks, a fifth solution has been developed that relies on a hybrid system using both permanent magnets and electromagnets and which thus allows the electrical consumption of the system to be slightly reduced. Such a levitation is called “partially passive” levitation. Thus, a partially passive levitation device is known which comprises a cylindrical rotor in levitation between two rare-earth permanent magnets developing a field of 1.1 tesla, but ensuring only radial stability. In the absence of complementary stabilization, the system is therefore very unstable axially. To achieve this stabilization, each permanent magnet is associated with a servocontrolled electromagnet so as to ensure axial stabilization of the rotor about a mean equilibrium position. The use of permanent magnets makes it possible, on the one hand, to have a system with a linear transfer function and, on the other hand, to ensure centering by reluctance even if the electromagnets are not powered, the latter being used only for increasing or reducing the permanent field applied, and thus to displace the equilibrium of the forces being applied on the rotor. However, the electrical consumption of such a system remains relatively high and still requires the installation of a sensor associated with a complex and high-speed servo-control system.

Because of these technical and economic constraints, this technology is used only within the context of very specific applications for which the energy cost is almost of no consideration.

One of the main current applications of magnetic levitation is for magnetic bearings, especially for inertial flywheel systems and other rotating devices. Inertial flywheel systems are used to store energy in kinetic form in a rotating flywheel, the axis of which is kept constant by magnetic bearings so as to restore the energy in the event of the current being cut off or an irregular power supply. For example, when the electricity generation of a wind turbine is sufficient to power an electrical system, some of this current is used to drive the inertial flywheel system by means of a motor/generator and to keep its speed at several thousand revolutions per minute. In the event of a drop in electricity generation by the wind turbine, the speed of the inertial flywheel system is converted, thanks to the same motor/generator then operating in generator mode, into electricity. This makes it possible to ensure constant power supply until a rise in electricity generation. To optimize the energy storage, to minimize the friction losses and to restore the energy with maximum efficiency over the longest possible period of time, the levitation of the flywheel must be very precisely controlled and must consume the least possible electrical power for controlling this levitation. As explained above, most of the current solutions fail to achieve these objectives—levitation using permanent magnets, which therefore do not consume electrical energy, is impossible because of Earnshaw's law, whereas active levitation especially requires a very large amount of electrical energy. This problem may also apply to magnetically levitated trains for which the operating cost, in addition to the already high installation cost, is excessive compared with the expected profitability, whether the levitation is provided using coils requiring very high electrical power or whether it uses superconductors that generally have to be kept in a bath of liquid nitrogen.

The object of the present invention is to remedy the abovementioned drawbacks and consists, to do this, of a method of stabilizing a magnetically levitated object subjected to at least one constant magnetic field, said object being stable in at least one direction and unstable in at least one other direction, characterized in that it includes a stabilizing step, repeated as often as necessary, which consists in applying an electrical current through at least one conducting element subjected to a secondary magnetic field so as to generate a compensating Lorentz force in the direction of instability.

Thus, thanks to the application of a compensating Lorentz force, it is easy to compensate for the magnetic instabilities inherent in the system, while minimizing its electrical consumption.

This is because an object in a stable magnetic field possesses potential energy of the harmonic type, the Laplacian of which, namely the sum of the second partial derivatives with respect to the spatial coordinates, is zero. Thus, the second partial derivatives of the potential energy with respect to each of the spatial coordinates cannot all be negative, as a perfectly stable equilibrium would desire. Consequently, there is still at least one coordinate with respect to which the second partial derivative is positive, therefore for which there is no stable equilibrium position. It has been found, surprisingly, that by applying a Lorentz force, the potential of which is quadratic, in the direction of the instability it is possible to give the system a potential energy for which stable points exist. Consequently, it is no longer necessary to use powerful electromagnets to stabilize such a system, and the overall electrical consumption is thereby considerably reduced.

The magnetic field for levitating the object may be generated by one or more magnetic field sources depending on the geometry of the object. It may prove necessary to use at least two magnetic sources to create a magnetic field in the desired direction so as to enhance the stability of the object.

Advantageously, the aim of the stabilizing step is to keep the object between an upper bound and a lower bound around a desired mean equilibrium position. This is because, a greater or smaller Lorentz force has to be exerted depending on the desired degree of stability. The more precisely the equilibrium has to be maintained, the more necessary it is to compensate for the instabilities of the system by applying larger compensating forces. Advantageously, it is possible to apply a Lorentz force providing about 10% of the total lift needed to levitate the object, the remaining 90% being provided by the permanent magnets.

Also advantageously, the method according to the invention includes a step of detecting the position of the object, capable of initiating and/or interrupting the flow of the electrical current through the conducting element. Thus, the electrical current is applied only when needed to bring the object back to its mean equilibrium position, thereby further reducing consumption. Accepting a slight oscillation about a desired mean equilibrium point, it is possible to further reduce the electrical consumption of the system.

The subject of the present invention is also a magnetic levitation device comprising an object in levitation subjected to at least one constant magnetic field, interacting with corresponding magnetization means of the levitated object, characterized in that it includes, on the one hand, secondary magnetic elements that are capable of generating a secondary magnetic field and, on the other hand, at least one conducting element subjected to the secondary magnetic field, so that a compensating Lorentz force is generated on the levitated object when an electrical current flows through the conducting element.

It should be noted that the expression “by corresponding magnetization means” should be understood to mean any material sensitive to a surrounding magnetic field. Such materials are of course magnets, which react to another magnet, but also ferromagnetic materials, which are nonmagnetized per se but are magnetically oriented when placed in a magnetic field.

It must be clearly understood that the constant magnetic field is generated by at least one field source, it being possible for the magnetic field source and the corresponding magnetization means to be reversed in such a way that the field source is located on the object and interacts with an external corresponding magnetization means.

Preferably, the magnetic field, together with the corresponding magnetization means, develops an attractive force that is exerted on the levitated object. It is also possible for the magnetic field, together with the corresponding magnetization means, to develop attractive forces and repulsive forces that are exerted on the levitated object.

According to an alternative embodiment, the magnetic field is generated by at least two magnetic field sources, the magnetic field sources and the corresponding magnetization means of the levitated possessing a parallel magnetic orientation in the same direction. For example, in the case of a system with symmetry of revolution, two interacting concentric permanent magnet rings are used, one of the rings being integral with a stator, whereas the other ring is integral with the levitated object, for example a rotor.

Preferably, the conducting element is a coil. In general, a conducting element made of silver is preferred, this metal being one of the best conductors currently known. It may also be envisaged to use carbon nanotubes. Of course, the intensity of the Lorentz force developed may vary according to the aspect ratio of the coil, this aspect ratio preferably being defined so as to maximize the Lorentz force in the direction contributing to the stability for a minimum electrical current in the coil. Advantageously, the coil is wide and thin.

Also preferably, the magnetic field sources and/or the complementary magnetization means and/or the secondary magnetic elements are permanent magnets. Advantageously, the permanent magnets are magnets based on neodium-iron-boron. Also advantageously, the magnets are placed in what is called a Halbach configuration, so as to obtain both a maximum main field and minimum parasitic fields.

According to an alternative embodiment, the secondary magnetic elements interact with at least one ferromagnetic material shaped so as to allow the secondary magnetic field to be reoriented.

Preferably, the device includes at least one sensor capable of initiating or interrupting the flow of the current through the conducting element according to the position of the levitated object. Thus, it is unnecessary for the conducting element to be permanently powered, thereby further reducing the electrical consumption of the system. The current in the conducting element may also be controlled by a servo-controlled circuit of the on/off type, proportional, integral or derivative type, or any combination of these depending on the position of the levitated object.

Advantageously, the sensor includes a tip integral with the levitated object and capable of coming into contact with a switch in order to close it.

The implementation of the invention will be better understood from the detailed description presented below, in conjunction with the appended drawing in which:

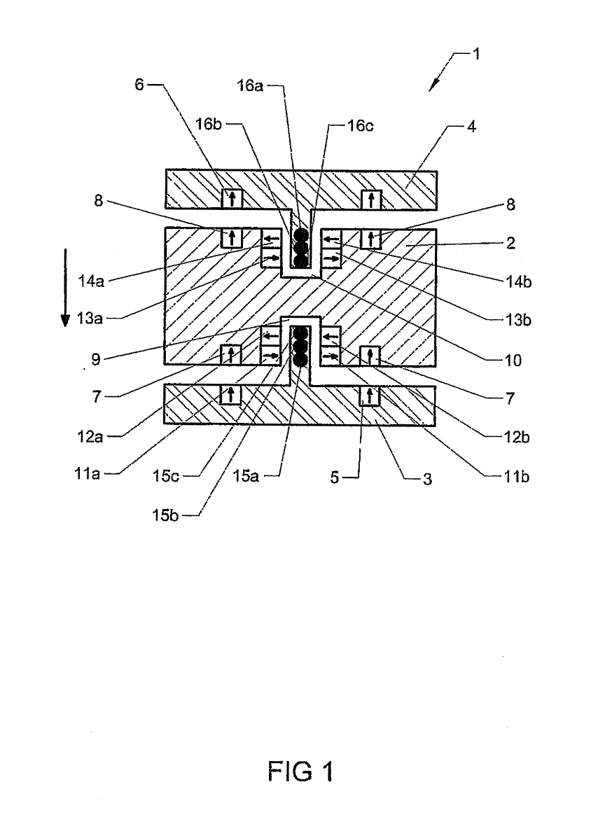

FIG. 1 is a schematic longitudinal sectional representation of a first embodiment of an inertial flywheel system axially stabilized using the method of the invention;

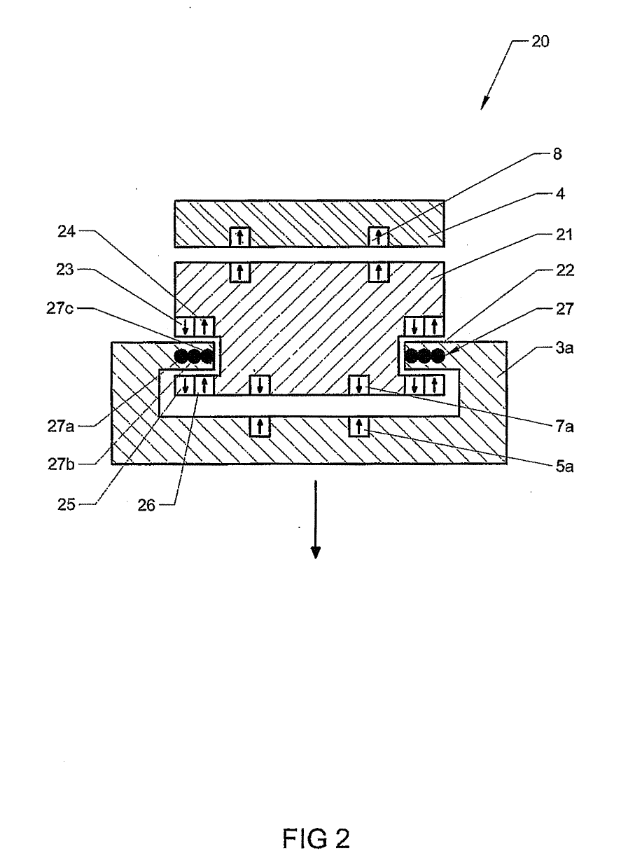

FIG. 2 is a schematic longitudinal sectional representation of a second embodiment of an inertial flywheel system radially stabilized using the method of the invention;

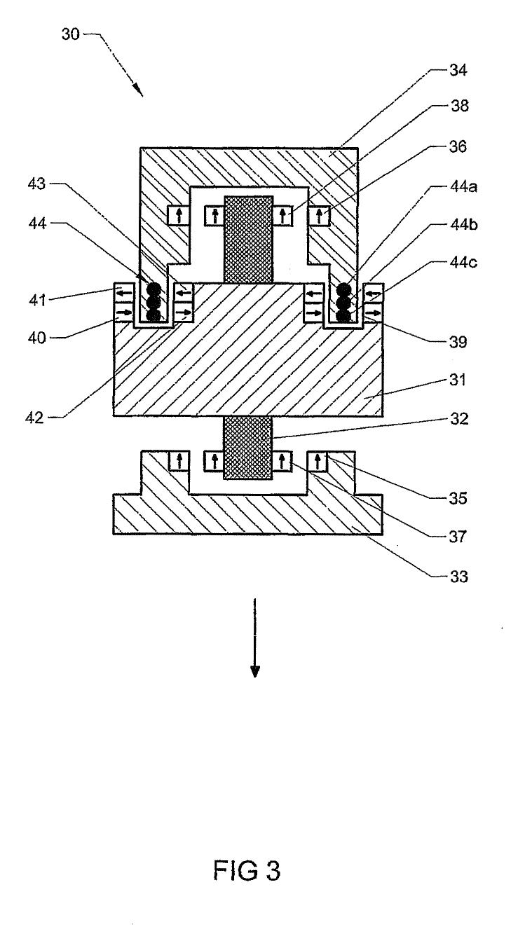

FIG. 3 is a schematic longitudinal sectional representation of a third embodiment of an inertial flywheel system axially stabilized using the method of the invention;

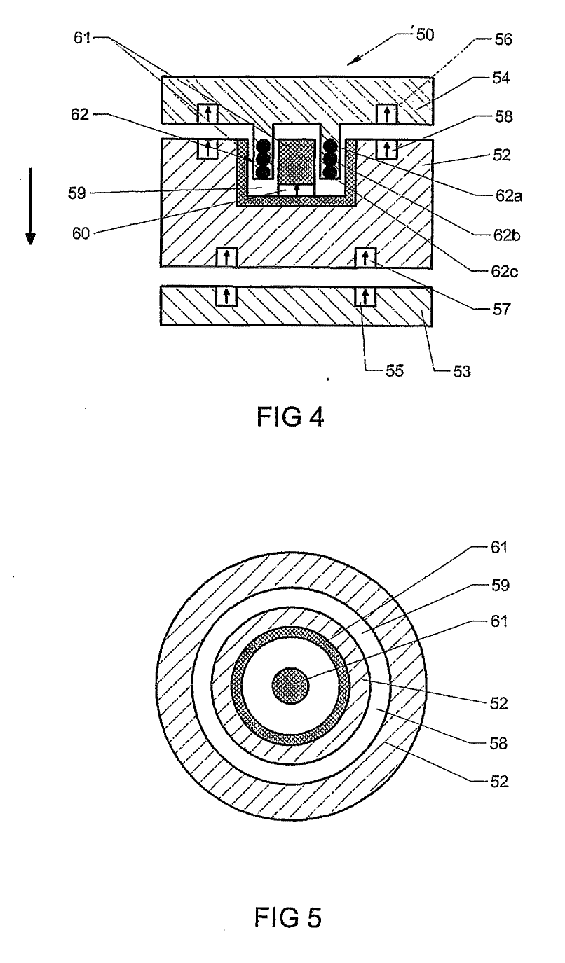

FIG. 4 is a schematic longitudinal sectional representation of a fourth embodiment of an inertial flywheel system stabilized according to the invention, and using soft iron to reorient the magnetic fields.

FIG. 5 is a sectional top view of the inertial flywheel system of FIG. 4;

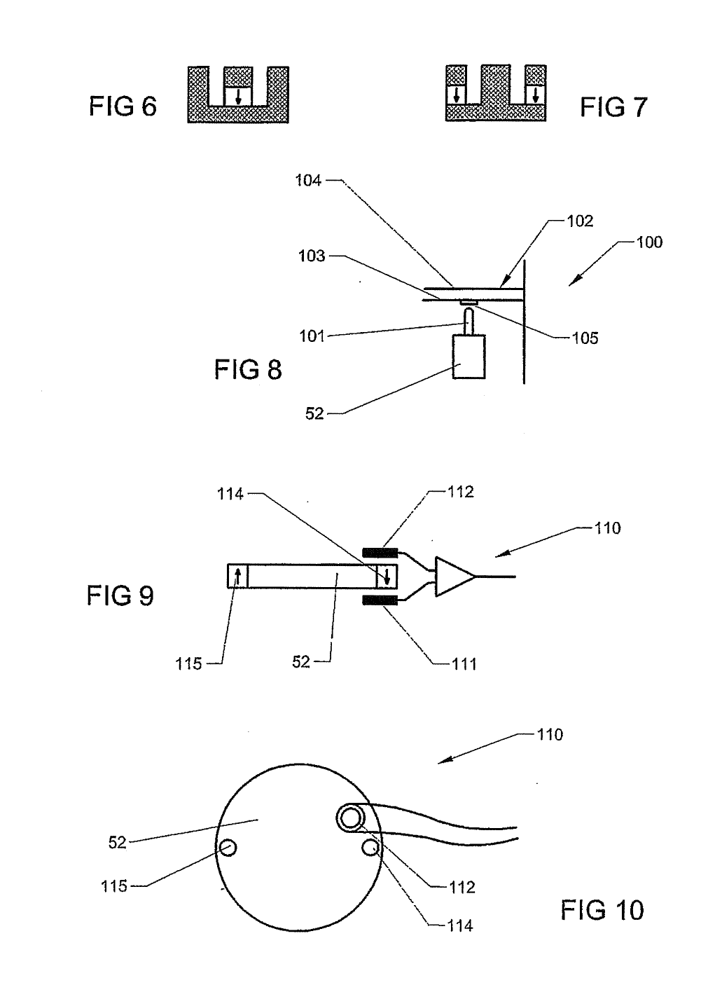

FIGS. 6 and 7 show two embodiments of the reorientation of the magnetic field using soft iron;

FIG. 8 is a schematic representation of a first embodiment of an instability detector;

FIG. 9 is a schematic representation of a second embodiment of an instability detector;

FIG. 10 is a top view of the sensor of FIG. 9; and

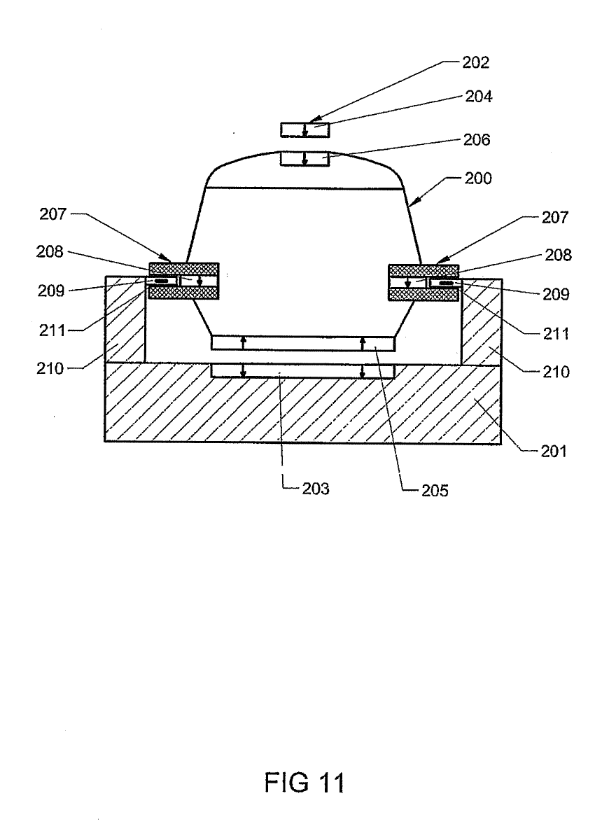

FIG. 11 is a schematic representation of an alternative way of applying the stabilization method according to the invention to a magnetically levitated train.

An inertial flywheel system 1, as shown in FIG. 1, comprises a cylindrical flywheel 2 in magnetic levitation between a lower magnetic source 3 and an upper magnetic source 4. Each magnetic source 3, 4 comprises a respective circular magnet 5, 6 facing a respective circular magnet 7, 8 corresponding to the flywheel 2.

Moreover, the flywheel 2 has a central lower cavity 9 and a central upper cavity 10. The lower cavity 9 houses two superposed pairs of additional magnets 11a, 11b, 12a, 12b, the radial magnetic field developed by one of the two pairs of additional magnets 11a, 11b, 12a, 12b opposing the field developed by the other pair of additional magnets 12a, 12b, 11a, 11b. Likewise, the upper cavity 10 houses two superposed pairs of additional magnets 13a, 13b, 14a, 14b.

The lower cavity 9 and the upper cavity 10 are each intended to accommodate, respectively, a set of conducting wires 15a, 15b, 15c, 16a, 16b, 16c integral with the corresponding magnetic source 3, 4 and placed perpendicular to the axis of the flywheel 2. Each set of conducting wires 15a, 15b, 15c, 16a, 16b, 16c is connected to a power supply circuit (not shown).

The orientation of the poles of the circular magnets 5 to 8 is chosen so that the circular magnets 5, 7 on the one hand, and 6, 8 on the other, develop respectively between them an attractive magnetic force. The powers of the circular magnets 5 to 8 are chosen so that the attractive force tending to move the flywheel 2 toward the upper source 4 is in equilibrium with the attractive force tending to move the flywheel 2 toward the lower source 3 increased by the force exerted by gravity (shown symbolically by an arrow), that is to say the weight of the flywheel 2.

Moreover, the magnets 5, 6 exert a large centering force on the flywheel 2, said magnets tending to align the magnetic axis of the corresponding magnets 7, 8 with their own. This centering force is sufficient to stabilize the flywheel radially.

According to Earnshaw's law, the flywheel 2 in levitation between the lower source 3 and the upper source 4 cannot be stable. Specifically, since the centering force of the magnets 5 to 8 arranged attractively is particularly large, this force gives the flywheel 2 radial stability but imposes axial instability. Thus, in the absence of any complementary field regulation, the flywheel 2 will naturally have a tendency to come into contact with the lower magnetic source 3 or the upper magnetic source 4.

Axial stability is provided by the interactions between each of the additional magnets 11a to 14b and the sets of corresponding conducting wires 15a to 16c. What happens is that, when an electrical current flows through a conductor subjected to a perpendicular magnetic field, said conductor experiences a Lorentz force forming, with the current and field vectors, a direct orthonormal reference frame.

Thus, each of the sets of conducting wires 15a to 16c through which an electrical current flows interact with the corresponding additional magnets 11a to 14b. In this case, the orientation of the additional pairs of magnets 11a to 14b and the direction of the electrical current flowing through the conducting wires 15a to 16c are chosen so that when the flywheel 2 approaches the lower source 3, the Lorentz force generated is directed axially and tends to move the flywheel 2 away from the lower source 3. Correspondingly, when the flywheel 2 approaches the upper source 4, the Lorentz force generated must be directed axially and tend to move the flywheel 2 away from the upper source 4.

In the arrangement shown in FIG. 1, when the flywheel 2 is in equilibrium, one half of the conducting wires 15a to 16c are subjected to the radial magnetic field of the pairs of additional magnets 11a, 11b, 14a, 14b, whereas the other half of the conducting wires 15a to 16c are subjected to the radial magnetic field of the pairs of additional magnets 12a, 12b, 13a, 13b in the same direction but in the opposite sense to the field of the pairs of additional magnets 11a, 11b, 14a, 14b. The Lorentz force resulting from these two effects is therefore zero. In this case, it has been considered, for the example, that the power of the additional magnets 11a to 14b is the same and that the same electrical current flows through the conducting wires 15a to 16c. However, it is of course possible to obtain such an equilibrium with magnets of different power and with different electrical currents.

However, as explained, the flywheel 2 is axially unstable and tends to move either toward the lower source 3 or the upper source 4. When the flywheel 2 moves toward the lower source 3, the conducting wires 15a to 15c are then mainly subjected to the magnetic field of the pair of additional magnets 12a, 12b, whereas the conducting wires 16a to 16c are mainly subjected to the magnetic field of the pair of additional magnets 13a, 13b of the same magnetic orientation as the pair of additional magnets 12a, 12b. The direction of the electrical current flowing through the conducting wires 15a to 16c is chosen so that the flywheel 2 experiences a Lorentz force tending to move the flywheel 2 away from the lower source 3 toward the upper source 4. It should be noted that this case is also applicable to the flywheel before it is put into levitation, the Lorentz force thus created participating in lifting it up off the lower magnetic source 3.

Likewise, when the flywheel 2 moves toward the upper source 4, the set of conducting wires 15a to 15c is mainly subjected to the field of the pair of additional magnets 11a, 11b, whereas the conducting wires 16a to 16c are mainly subjected to the field of the pair of additional magnets 14a, 14b of the same magnetic orientation. Since the magnetic orientation of the pairs 11a, 11b and 14a, 14b is opposite that of the pairs 12a, 12b on the one hand, and 13a, 13b on the other, the resulting Lorentz force therefore has an opposite direction and tends to move the flywheel 2 away from the upper source 4 in order to bring it back to its initial unstable equilibrium position.

In this way, the flywheel 2 is stabilized axially without using any sensor or any system for regulating the electrical current, and it oscillates on either side of a mean equilibrium position. Experiments have shown that the intensity of the electrical current needed to stabilize a flywheel 2 having a mass of 2.4 kg is only about 15 milliamps.

An inertial flywheel system 20, as shown in FIG. 2, comprises a flywheel 21 differing from the flywheel 2 mainly by the fact that it is subjected to a lower magnetic source 3a comprising a circular magnet 5a that interacts with a corresponding circular magnet 7a of the flywheel 21 so as to develop, between them, a repulsive force that opposes the drop of the flywheel 21 by gravity (shown symbolically by an arrow). Unlike the flywheel 2 of the inertial flywheel system 1, the flywheel 21 is axially stable but radially unstable, the lower magnetic source 3 tending to push the flywheel 21 laterally. Consequently, the flywheel 21 must therefore be stabilized radially using the method according to the invention.

To do this, the flywheel 21 includes a peripheral lateral groove 22 comprising adjacent circular upper additional magnets 23, 24 and lower additional magnets 25, 26, which are also circular and adjacent, said lateral groove 22 being intended to accommodate a set of conducting wires 27a, 27b, 27c forming turns of a coil 27 through which a constant electrical current flows. The additional magnets 23 and 25 are located facing each other and possess an identical magnetic orientation. The additional magnets 24 and 26 are also located facing each other and possess an identical magnetic orientation, but opposite the magnetic orientation of the additional magnets 23, 25.

As in the case of the inertial flywheel system 1, when the flywheel 20 is in equilibrium, the coil 27 has as many turns subjected to the magnetic field of the additional magnets 23, 25 as turns subjected to the magnetic field of the additional magnets 24, 26, and the resulting Lorentz force is therefore zero. When the flywheel 21 deviates radially, the coil 27 is, in the direction in which the flywheel 21 deviates and irrespective of this direction, mainly subjected to the magnetic field of the additional magnets 24, 26, whereas in the diametrically opposed direction said coil 27 is mainly subjected to the magnetic field of the additional magnets 23, 24 which is opposite that of the additional magnets 24, 26. Since the sense of the current flowing through the coil 27, in the direction in which the flywheel 21 deviates, is opposite that of the diametrically opposed direction, the Lorentz force generated on either side of the flywheel 21 has one direction and an identical sense. The sense of the current flowing through the coil 27 and the orientation of the additional magnets 23 to 26 are chosen so that the Lorentz force being exerted in the direction in which the flywheel 21 deviates is centripetal, thus returning the flywheel 21 into its equilibrium position, the corresponding Lorentz force being exerted in the diametrically opposite direction then being centrifugal.

Thus, the flywheel 21 is stabilized radially and oscillates about its axis.

FIG. 3 shows a third embodiment of an inertial flywheel system stabilized using the method of the invention. This inertial flywheel system 30 comprises a cylindrical flywheel 31 having a shaft 32 and held in magnetic levitation between a lower magnetic source 33 and an upper magnetic source 34. Each magnetic source comprises an annular magnet 35, 36 through which the shaft 32 passes, the magnets 35, 36 possessing an axial magnetic orientation and each interacting with a corresponding concentric magnet 37, 38 located on the shaft 32 of the flywheel 31 at the same height as said magnets 35, 36.

The orientation of the magnets 35 to 38 is chosen to be the same, the magnets 35, 37 on the one hand, and 36, 38 on the other, developing respectively, between them, a magnetic force for centering the shaft 32. The flywheel 31 is therefore radially stable, but exhibits axial instability stabilized by the method according to the invention.

To do this, the flywheel 31 has an upper peripheral groove 39 housing two superposed circular outer additional magnets 40, 41 and two superposed inner additional magnets 42, 43, said groove 39 being intended to accommodate a set of conducting wires 44a, 44b, 44c forming turns of a coil 44 through which a constant electrical current flows. The additional magnets 40 and 42 are concentric and possess the same magnetic orientation. The additional magnets 41 and 43 are also concentric and possess an identical magnetic orientation but opposite the magnetic orientation of the additional magnets 40, 42.

As in the case of the inertial flywheel systems 1 and 20, when the flywheel 30 is in equilibrium, the coil 44 possesses as many turns subjected to the magnetic field of the additional magnets 40, 42 as turns subjected to the magnetic field of the additional magnets 41, 43, and the resulting Lorentz force is therefore zero. When the flywheel 30 deviates axially and moves toward the lower magnetic source 33, the coil 44 is then mainly subjected to the magnetic field of the additional magnets 41, 43. The orientation of the additional magnets 41, 43 and the direction of the electrical current through the coil 44 are chosen so that the Lorentz force generated tends to move the flywheel 30 away from the lower source 33 and bring it back to its initial unstable equilibrium position. Likewise, when the flywheel 30 moves toward the upper magnetic source 34, the coil 44 is then mainly subjected to the magnetic field of the additional magnets 40, 42. Since the orientation of the additional magnets 40, 42 is opposite the orientation of the magnets 41, 43, the Lorentz force generated tends to move the flywheel 30 away from the upper source 34 and bring it back to its initial unstable equilibrium position.

Thus, the flywheel 30 is stabilized axially and oscillates about a mean equilibrium position.

As a variant, it is possible to use fewer magnets and to control the orientation of their field using soft iron. An inertial flywheel system 50, as shown in FIG. 4 constitutes one exemplary embodiment thereof.

This inertial flywheel system 50 comprises a cylindrical flywheel 52 in magnetic levitation between a lower magnetic source 53 and an upper magnetic source 54. Each magnetic source 53, 54 comprises a respective circular magnet 55, 56 facing a corresponding circular magnet 57, 58 of the flywheel 52.

Moreover, the flywheel 52 has a central annular groove 59, the center of which houses an additional magnet 60 developing an axial magnetic field, said groove 59 having walls covered with a layer of soft iron 61 in order to reorient the magnetic field of the additional magnet 60 in a radial direction. Other provisions of soft iron near additional magnets are shown in FIGS. 6 and 7.

The groove 59 is intended to accommodate a set of conducting wires 62a, 62b, 62c forming a coil 62 integral with the upper magnetic source 64, the coil 62 possessing an axis that merges with the axis of the flywheel 52. The coil 62 is connected to a power supply circuit (not shown).

As in the case of the inertial flywheel system 1, the magnetic orientation of the magnets 55 to 58 is chosen so that the magnets 55, 57 on the one hand, and 56, 58 on the other, develop respectively, between them, an attractive magnetic force. The powers of the magnets 55 to 58 are chosen so that the attractive force tending to move the flywheel 52 toward the upper source 54 is in equilibrium with the attractive force tending to move the flywheel 52 toward the lower source 53 increased by the force exerted by gravity (shown symbolically by an arrow), i.e. the weight of the flywheel 52.

Axial stability is provided by the interactions between the coil 62 and the magnetic field developed by the additional magnet 60, generating a complementary Lorentz force.

According to the arrangement shown in FIGS. 4 and 5, when the flywheel 52 is in equilibrium, no Lorentz force is generated and the coil 62 is not powered. When the flywheel 52 moves toward the lower source 53, an electrical current is applied to the terminals of the coil 62, the direction of the current being chosen so as to generate a Lorentz force directed axially and tending to move the flywheel 52 away from the lower source 53 in order to bring it back to its initial unstable equilibrium position. When the flywheel 52 moves toward the upper source 54, it is necessary to generate a Lorentz force tending to move the flywheel 52 away from the upper source 54. To do this, since the magnetic field of the additional magnet acting on the coil 62 is constant, it is necessary to reverse the direction of the current flowing through said coil 62.

As a complement in this device, it is therefore necessary to provide a sensor for detecting whether the flywheel 52 is moving toward the lower source 53 or the upper source 54, so as to apply the current in the desired direction when necessary. Unlike the previous devices, for which no sensor is necessary but in which the electrical conductors are permanently powered, the coil 62 of the inertial flywheel system 60 does not need to be permanently powered, thereby further reducing the electrical consumption of the device. However, it does require coupling of the power supply circuit to a sensor.

Examples of sensors are shown in FIGS. 8 to 10.

FIG. 8 shows a mechanical sensor 100 comprising a tip 101 having an extremely fine and strong point terminating in a very small diameter (less than 1 mm) ball made of very hard material, said tip being intended to be fastened to the center of the flywheel 52. A switch 102 comprising two conducting plates 103, 104, the plate 104 being stationary and fastened to the framework of the inertial flywheel system. These two plates 103, 104 are connected to the power supply. More precisely, the plate 103 is intended to be in contact with the tip 101 and comprises, for this purpose, an extremely hard plate 105 made of ruby. When, under the effect of the Lorentz force, the flywheel 52 moves toward the upper source 53, the tip exerts a very small force (a few hundred milligrams) on the plate 105 and pushes the plate 103 into contact with the plate 104, thereby closing the electrical circuit and causing the current to flow. This has the effect of eliminating the Lorentz force and the flywheel 52 then drops back down, moving away from the upper source 54. This moves the tip 101 away and reopens the electrical circuit, with the effect that the Lorentz force is reestablished. The same applies with a second sensor, for the lower source 53. This type of operation means that the flywheel 52 oscillates with a very small amplitude on either side of the metastable Earnshaw equilibrium point or very close to this point, thereby making it possible to limit the levitation power to very small values, taking into account the mass of the flywheel 52.

FIGS. 9 and 10 show a sensor 110 comprising a lower magnetic loop 111 and an upper magnetic loop 112 lying respectively above and below the passage for the two magnets 114, 115 integral with the flywheel 52 and able to have an opposite magnetic orientation. It is of course possible to place several magnets similar to the magnets 114, 115 at regular intervals over the periphery of the flywheel 52, possibly alternating their magnetic orientations. When the flywheel is rotating, the lower magnetic loop 111 and upper magnetic loop 112 are subjected to an alternating field inducing alternating electrical currents in phase opposition in said loops 111, 112. These induced currents are added by a comparator 116 and the resulting current is directed into the coil 62 in order to power it. Optionally, it is possible to add thereto an operational amplifier if the induced electromotive forces are insufficient. This is because when the flywheel 52 moves toward the upper source 54, the upper magnetic loop 112 is subjected to a stronger magnetic field than the lower magnetic loop 111, and therefore generates a higher induced electromotive force, the sum of the induced electromotive forces is therefore in favor of the upper loop 112, and the coil 62 is powered by a current flowing in the corresponding direction. Conversely, when the flywheel 52 moves toward the lower source 53, the upper magnetic loop 112 is subjected to a weaker magnetic field than the lower magnetic loop 111, and therefore generates a less intensive induced electromotive force, the sum of the induced electromotive forces is therefore in favor of the lower loop 111, and the coil 62 is powered by a current flowing in the opposite direction from the previous case and generates a reverse Lorentz force.

It should be noted that the examples mentioned describe coils or conducting wires integral with the upper and/or lower sources, while the flywheels comprise additional magnets. Of course, this arrangement may be reversed, the coil or the conducting wires being integrated into the flywheel while the additional magnets are integrated into the upper and/or lower sources, and the power supply for the coil or conducting wires is produced using a generator internal to the flywheel. However, this embodiment is more difficult to implement and the arrangements as described above are preferred.

FIG. 11 shows an alternative way of applying the method according to the invention to a magnetically levitated train 200. This train 200 is in levitation between a lower rail 201 and an upper rail 202 by means of magnets 203, 204, each cooperating with a magnet 205, 206 on the train so that the magnet 203 of the lower rail 201 develops with the corresponding magnet 205 on the train 200 a repulsive force, whereas the magnet 204 of the upper rail 202 develops with the corresponding magnet 206 on the train 200 an attractive force. According to Earnshaw's law, the train is laterally unstable and must be stabilized using the method according to the invention. To do this, the train 200 is equipped with lateral rails 207 made of soft iron, comprising an additional magnet 208 possessing a vertical magnetization. This rail 207 is intended to accommodate a fixed additional rail 209 integral with a channel 210 along which the train runs. Passing through this additional rail 209 are conducting wires 211 supplied with electrical current and subjected to the magnetic field developed by the additional magnet 208. It is therefore possible to generate a Lorentz force exerted on the train 200 and allowing its magnetic instabilities to be corrected.

It should be noted that one of the main advantages of the method and device forming the subject matter of the invention lies in the fact that it does not operate by modifying the lifting and positioning magnetic fields and that the position of the levitated object is located at the metastable Earnshaw equilibrium point or very close to this point, thereby making it possible to limit the levitation power to extremely low values, taking into account the magnitude of the mass of the levitated object.

Although the invention has been described in conjunction with particular embodiments, it is of course in no way limited thereto and that it includes all the technical equivalents of the means described and their combinations provided that they fall within the scope of the invention.

1. A method of stabilizing a magnetically levitated object subjected to at least one constant magnetic field, said object being stable in at least one direction and unstable in at least one other direction, comprising a stabilizing step, repeated as often as necessary, which comprises applying an electrical current through at least one conducting element subjected to a secondary magnetic field so as to generate a compensating Lorentz in the direction of instability.

2. The method as claimed in claim 1, wherein an aim of the stabilizing step is to keep the object between an upper bound and a lower bound around a desired mean equilibrium position.

3. The method as claimed in claim 1, further comprising detecting the position of the object capable of initiating and/or interrupting the flow of the electrical current through the conducting element.

4. A magnetic levitation device comprising an object in levitation subjected to at least one constant magnetic field, capable of interacting with corresponding magnetization means of the levitated object, comprising, on the one hand, secondary magnetic elements that are capable of generating a secondary magnetic field and, on the other hand, at least one conducting element subjected to the secondary magnetic field, so that a compensating Lorentz is generated on the levitated object when an electrical current flows through the conducting element.

5. The device as claimed in claim 4, wherein the magnetic field, together with the corresponding magnetization means, develops an attractive force that is exerted on the levitated object.

6. The device as claimed in claim 4, wherein the magnetic field is generated by at least two magnetic field sources, the magnetic field sources and the complementary magnetization means of the levitated object possessing a parallel magnetic orientation in the same direction.

7. The device as claimed in claim, wherein the conducting element is a coil.

8. The device as claimed in claim, wherein the magnetic field sources and/or the complementary magnetization means and/or the secondary magnetic elements are permanent magnets.

9. The device as claimed in claim, wherein the secondary magnetic elements interact with at least one ferromagnetic material shaped so as to allow the secondary magnetic field to be reoriented.

10. The device as claimed in claim, wherein it includes at least one sensor capable of initiating or interrupting the flow of the current through the conducting element according to the position of the levitated object.

11. The device as claimed in claim 10, wherein the sensor includes a tip integral with the levitated object and capable of coming into contact with a switch in order to close it.
